(19) United States
(12) Patent Application Publication
(10) Pub. No.: US 2005/0220960 A1
(43) Pub. Date: Oct. 6, 2005

(54) Collagen protein breads, cereals, rice, pastas

(76) Inventor: Joseph F. Godlewski, Cresaptown, MD (US)

Correspondence Address: Joseph F. Godlewski, 13208 2nd Ave, Cresaptown, MD, 21502, US

(21) Appl. No.: 10/816,963

(22) Filed: Apr. 5, 2004

(51) Int. Cl. A21D 10/00

(52) U.S. Cl. 426/549

(57) ABSTRACT

The Collagen Protein Breads, Cereals, Rice Products, and Pastas are made by combining an additive of ground (powdered) collagen to flour made of any grain or rice. These flours are then used to make bread, cereal, rice products, or pasta.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The object of this invention is to provide added protein to breads, cereals, rice, and pastas.

### BRIEF SUMMARY OF THE INVENTION

A protein additive made from powdered collagen is mixed with any grain, rice, or pasta flour to make a bread, cereal, pasta, or rice product to provide protein that is otherwise absent from these products.

### BRIEF DESCRIPTION OF THE SEVERAL VIEWS OF THE DRAWING

Not Applicable

### DETAILED DESCRIPTION OF THE INVENTION

Collagen, a beef by-product, is ground into a powder. This powder is then combined with any grain or rice flour and made into breads, rolls, buns, flat breads, cereals, pastas. Instead of getting nourishment solely from the bread there is additional protein added from the collagen.

1. When collagen is ground it can be added to flour or cornmeal which then can be used to make breads, cereals, rice products, or pastas.

2. Referring to claim 1, the ground collagen adds a necessary protein to the diet of a human or animal.

3. Referring to claim 1, the ground collagen adds additional fiber to the breads, cereals, rice products, or pastas.

4. Referring to claim 1, the powdered collagen can be added to flour to make breads, rolls, flat breads, and pita breads.

5. Referring to claim 3, the breads become healthier with the added protein.

6. Referring to claim 3, the collagen makes the bread less soggy.

7. Referring to claim 3, the collagen makes the bread firmer and thus enables the bread to be thinly sliced which reduces a person's carbohydrate intake.

8. Referring to claim 3, the powdered collagen adds freshness to the bread.

9. Referring to claim 3, when the bread becomes stale it can be made into croutons.

10. Referring to claim 1, the ground collagen prevents pasta from becoming mushy.
